(19) United States
(12) Patent Application Publication
(10) Pub. No.: US 2025/0229464 A1
(43) Pub. Date: Jul. 17, 2025

(54) STRUCTURE, SLIDING MATERIAL, AND MANUFACTURING METHOD THEREOF

(71) Applicant: Mitsubishi Corporation, Tokyo (JP)

(72) Inventors: Takako SAKAGUCHI, Tokyo (JP); Sota TAINAKA, Tokyo (JP); Takuya MINAMI, Tokyo (JP); Takeshi IGARASHI, Tokyo (JP); Kunio KONDO, Tokyo (JP)

(21) Appl. No.: 18/700,456

(22) PCT Filed: Oct. 11, 2022
(86) PCT No.: PCT/JP2022/037770

§ 371 Date: Sep. 9, 2024

(30) Foreign Application Priority Data
Oct. 13, 2021 (JP) 2021-168395

(51) Int. Cl. B29C 33/60; B29C 33/58

(52) U.S. Cl. CPC B29C 33/60; B29C 33/58; B29K 2905/12

(57) ABSTRACT

A step is included in which an iron oxide is immersed in a benzotriazole solution containing a fullerene. The immersion is performed until a fullerene concentration in the benzotriazole solution decreases compared with that before the immersion, and a structure is obtained having the fullerene on the surface of the iron oxide. A sliding body is used in which the surface of the iron oxide having the fullerene of the structure is arranged on a sliding surface.

### TECHNICAL FIELD

The present disclosure relates to a structure, a sliding material, and a manufacturing method thereof.

### BACKGROUND ART

It is known that the presence of fullerenes on the surface improves sliding properties and mold release properties.

For example, in Patent Document 1, a machined part or the like in which a nanometer-order fullerene is present on a machined surface (a new surface of a metal) with a coverage of 1.0 area % or more and 90.0 area % or less is disclosed, and once adsorbed on the new surface, the fullerene is not easily desorbed.

Further, in Patent Document 2, it is disclosed that a film containing a fullerene is formed on the surface of an object such as a mold coated with a carbon film containing at least one type of nanocarbon selected from the group consisting of carbon nanocoils, carbon nanotubes, and carbon nanofilaments, by applying alcohol containing fullerenes using a brush. According to Patent Document 2, although fullerenes are effective in improving surface properties, they have a disadvantage that they tend to fall off the mold surface, but according to the invention, by trapping fullerenes between the nanocarbons extending in a fibrous form from the surface, fullerenes can be prevented from falling off the mold surface.

### RELATED-ART DOCUMENT

### Patent Document

Patent Document 1: International Publication No. WO 2020/090964

Patent Document 2: International Publication No. WO 2010/067786

### SUMMARY OF INVENTION

### Technical Problem

Thus, it has been performed to coat a specific surface with fullerenes. However, in these methods, the surface of an iron member (that is, the surface of an iron oxide) on which a more common passive film or the like is formed is not directly coated with the fullerenes.

An object of the present invention is to provide a structure and a sliding material that solve the above problems, and a manufacturing method thereof.

### Solution to Problem

The present invention provides the following means to solve the problems.

[19]

A structure including:
an iron oxide; and
a fullerene,
wherein the fullerene is adsorbed on a surface of the iron oxide.
   [2]

The structure according to [1], wherein the adsorption of the fullerene is a chemical adsorption.

[3]

The structure according to [1] or [2], wherein the iron oxide is magnetite.

[4]

The structure according to any one of [1] to [3], wherein the fullerene covers an entirety of the surface of the iron oxide.

[5]

The structure according to any one of [1] to [4], further including a metallic iron,
wherein the iron oxide is a film formed on a surface of the metallic iron.
   [6]

A sliding material including:
the structure of any one of [1] to [5],
wherein the structure is arranged such that the surface of the iron oxide having the fullerene serves as a sliding surface.
   [7]

A manufacturing method of the structure of any one of [1] to [5], the manufacturing method including:
a step of immersing an iron oxide in a benzotriazole solution containing a fullerene,
wherein the step of immersing is performed until a fullerene concentration in the benzotriazole solution decreases compared with that before the step of immersing, and
wherein the structure has the fullerene on the surface of the iron oxide.
   [8]

The manufacturing method of the structure according to [7], wherein the benzotriazole solution further contains an alcohol.

[9]

The manufacturing method of the structure according to [7] or [8], wherein the step of immersing is performed until the fullerene concentration in the benzotriazole solution no longer changes after it has decreased compared with that before the step of immersing.

[10]

The manufacturing method of the structure according to any one of [7] to [9], further including, after the step of immersing, a step of washing the structure with an alcohol and drying the structure.

A manufacturing method of a sliding material, wherein
a structure is obtained by the manufacturing method of any one of [7] to [10], and
the surface of the iron oxide having the fullerene of the structure is arranged on a sliding surface.

### Advantageous Effects of Invention

According to the present invention, it is possible to improve the sliding properties and the like of the surface of an iron oxide.

### DESCRIPTION OF EMBODIMENTS

Hereinafter, embodiments of the present invention will be described in detail. The following embodiments are specifically described in order to better understand the purpose of the invention, and do not limit the present invention unless otherwise specified. As used herein, “X to Y” indicating a numerical range is meant to include a lower limit and an upper limit that are given as numerical values before and after “to”, unless otherwise noted.

### (Structure)

In a structure according to the present embodiment, at least a surface or a surface layer of the structure is composed of an iron oxide, and the structure includes the iron oxide and a fullerene. In the structure according to the present embodiment, preferably, at least the surface or the surface layer of the structure is composed of the iron oxide, and the fullerene is adsorbed on the surface of the iron oxide. The adsorption may be, for example, physical adsorption or chemical adsorption. Chemical adsorption, in which chemical bonds are formed and adsorption/desorption is irreversible, is preferable to physical adsorption, in which adsorption/desorption is reversible, from the viewpoint of difficulty in desorbing fullerenes from the surface of the iron oxide.

Examples of the iron oxide includes FeO, Fe₃O₄ (magnetite), Fe₂O₃ (hematite), and the like. From the viewpoint of ease of adsorption of fullerenes, which will be described later, it is more preferable that the oxidation number of iron is large, and from the viewpoint of wide application in forming a passive film, magnetite is more preferable.

The fullerene may be C₆₀, C₇₀, a higher order fullerene, a fullerene derivative, or a mixture thereof. Among the fullerenes, from the viewpoint of availability, C₆₀ or C₇₀ is preferable, yet C₆₀ is more preferable. When the fullerene is a mixture, it is preferable that C₆₀ is contained in an amount of 50 mass % or more.

The adsorption amount of the fullerene is preferably as large as possible, and up to a maximum of approximately 10⁶ fullerene molecules/μm² can be adsorbed per 1 μm² of the surface of the iron oxide. This corresponds to a state in which the fullerene covers the entire surface of the iron oxide, that is, a state in which the fullerene molecules are arranged in a single layer on the surface with the closest packing. As the lower limit of the adsorption amount, 1 fullerene molecule/μm² or more is preferable from the viewpoint of reducing the friction coefficient and 10² fullerene molecule/μm² or more is more preferable from this viewpoint. As the lower limit of the adsorption amount, 10⁴ fullerene molecule/μm² or more is even more preferable from the viewpoint of long-term stability such as desorption of the adsorbed molecules and 10⁵ fullerene molecule/μm² or more is particularly preferable from this viewpoint.

The iron oxide may be a film formed on the surface of metallic iron. In this case, the structure according to the present embodiment includes not only the iron oxide and the fullerene but also the metallic iron constituting a part of the structural member. The film is preferably a passive film from the viewpoint of protecting the metallic iron part.

### (Sliding Material)

A sliding material according to the present embodiment includes the structure. In the sliding material according to the present embodiment, the structure is arranged such that the surface of the iron oxide having the fullerene serves as a sliding surface. One of a pair of sliding materials forming a sliding part may be the sliding material according to the present embodiment, but it is preferable that both of the sliding materials forming the sliding part are the sliding materials according to the present embodiment from the viewpoint of reducing frictional resistance. The sliding surface may be coated with lubricating oil, lubricating grease, or the like.

### (Manufacturing Method of Structure)

A manufacturing method of the structure according to the present embodiment includes a step of immersing an iron oxide in a benzotriazole solution containing a fullerene. The immersion is performed until the fullerene concentration in the benzotriazole solution decreases compared with that before the immersion. This concentration decrease occurs because the fullerene is adsorbed on the surface of the iron oxide. That is, it can be assumed that the fullerene corresponding to the decrease in the fullerene concentration is adsorbed on the surface of the iron oxide.

In the immersion, it is sufficient that the surface of the iron oxide is covered with the benzotriazole solution. The immersion may be performed using a method such as spraying or coating, but preferably, the entire iron oxide is submerged in the benzotriazole solution from the viewpoint of ease of understanding the fullerene concentration described later.

The fullerene amount contained in the benzotriazole solution may be an amount sufficient to cover the adsorption amount of the fullerene. The fullerene amount is preferably 1.1 times or more of the adsorption amount, more preferably 10 times or more, and even more preferably 100 times or more from the viewpoint of enabling multiple immersions. In either case, the upper limit is the fullerene amount in the benzotriazole solution in which a saturated fullerene concentration is dissolved. The amount is preferably 1.1 times to 100 times the adsorption amount, and more preferably 1.1 times to 20 times, from the viewpoint of increasing the accuracy of analysis of the amount of decrease in the fullerene concentration.

Such a fullerene amount range can usually be readily achieved by setting the fullerene concentration in the benzotriazole solution to preferably 10 ppm by mass to 500 ppm by mass, more preferably 30 ppm by mass to 100 ppm by mass.

Because benzotriazole is a solid at room temperature, it may be used by heating to its melting point (about 100° C.) or more. However, from the viewpoint of ease of handling, benzotriazole may be made into a mixed solvent by adding an alcohol so that it becomes a liquid at a temperature where it can be easily handled, such as room temperature. The alcohol is preferably at least one alcohol selected from methanol, ethanol, 1-propanol, and 2-propanol, from the viewpoint of availability. For example, when ethanol is added to benzotriazole such that the mass ratio of ethanol to benzotriazole is 1:1, it is sufficient to handle as a liquid at room temperature, and when ethanol is added to benzotriazole such that the mass ratio of ethanol to benzotriazole is 1:1 to 3:1, it can be handled as a liquid even at a lower temperature.

When iron oxide is immersed in a benzotriazole solution containing fullerene, the fullerene is adsorbed on the surface of the iron oxide, reducing the fullerene concentration in the solution. The immersion may be completed when the desired fullerene amount is adsorbed, but from the viewpoint of increasing the fullerene amount adsorbed as much as possible, it is preferable to continue the immersion until the fullerene concentration in the benzotriazole solution no longer changes after it has decreased compared with that before the immersion.

After the immersion, the structure may be stored by applying or immersing with machine oil in the same manner as general mechanical parts, but from the viewpoint of ease of handling, it is preferable to wash the structure with alcohol and dry it. The alcohol is preferably at least one alcohol selected from methanol, ethanol, 1-propanol, and 2-propanol, from the viewpoint of availability.

Fullerenes are adsorbed on the surface of the iron oxide of the structure thus obtained. Even when the structure is washed with a good solvent for fullerenes such as toluene, almost no fullerenes are eluted and it is considered that most of the adsorbed fullerenes are chemically adsorbed. In chemical adsorption, it is considered that iron oxides and fullerenes are bonded via oxygen atoms.

### (Manufacturing Method of Sliding Material)

In the sliding material of the present embodiment, the surface of the iron oxide having the fullerene of the structure is arranged on the sliding surface. In the sliding material, a plurality of the structures may be arranged in accordance with the shape of the sliding surface, but an oxide film may be formed on the surface of the iron member in the shape of the sliding material, and the fullerene may be adsorbed on the surface.

Although the preferred embodiments of the present invention have been described in detail above, the present invention is not limited to a specific embodiment, and various variations or modifications are possible within the scope of the present invention described in the claims.

### EXAMPLES

Hereinafter, the present invention will be explained in more detail with reference to Examples and Comparative Examples, but the present invention is not limited to the following examples.

### Solution:

A solution of benzotriazole and ethanol at a mass ratio of 1:1 (hereinafter referred to as “mixed solvent”) was prepared.

A benzotriazole solution containing fullerene was prepared by adding fullerene to the mixed solvent at a concentration of 56.9 ppm by mass (hereinafter referred to as “immersion liquid”).

### Measurement Method:

### (Measurement of Fullerene Concentration)

Using a high-performance liquid chromatograph (Prominence-i LC-2030C 3D, manufactured by Shimadzu Corporation), the fullerene concentration in a sample was determined using a solution such as the immersion liquid as the sample under the following conditions.

Column: YMC-Pack ODS-AM manufactured by YMC Co., Ltd. (150 mm×4.6 mm)

Development solvent: 1:1 (volume ratio) mixture of toluene and methanol

Detection: absorbance (wavelength: 309 nm)

When dilution was necessary, the sample was diluted with the above development solvent in advance. The calibration curve was prepared using the fullerene used to prepare the sample.

When the sample contained oxidized fullerene, it was converted to unoxidized fullerene and added to the fullerene concentration. This is to prevent the oxidized fullerene produced by the side reaction between iron oxide and fullerene from being mistaken for adsorbed fullerene.

### (Measurement of Total Adsorption Amount)

The fullerene concentration in the immersion liquid before immersion and the fullerene concentration in the immersion liquid after immersion were measured, and the total adsorption amount of fullerene was calculated from the difference in the concentration of both fullerenes using the following formula (1).

Total adsorption amount (number of fullerene molecules/μm²)=K×(C₀−C₁)×V₁/(S×M) (1)

In the formula,

K: Constant, 6.02×10⁹

C₀: Fullerene concentration in the immersion liquid before immersion (ppm by mass)

C₁: Fullerene concentration in the immersion liquid after immersion (ppm by mass)

V₁: Volume of the immersion liquid (ml)

S: Surface area of the iron oxide part of the structure (cm²)

M: Molecular weight of the fullerene used, for example, 720 for C₆₀

### (Measurement of Physical Adsorption Amount and Chemical Adsorption Amount)

1 part by mass of a sample of a structure and the like obtained in each Example was immersed in 2 parts by mass of toluene and stirred for approximately 30 minutes. The physical adsorption amount was calculated from the fullerene concentration in the toluene after the immersion using the following formula (2).

Physical adsorption amount (number of fullerene molecules/μm²)=K×C₂×V₂/(S×M) (2)

In the formula,

K: Constant, 6.02×10⁹

C₂: Fullerene concentration in toluene after immersion in toluene (ppm by mass)

V₂: Volume of toluene (ml)

S: Surface area of the iron oxide part of the structure (cm²)

M: Molecular weight of the fullerene used, for example, 720 for C₆₀

As indicated in the following formula (3), the difference between the total adsorption amount and the physical adsorption amount was defined as the chemical adsorption amount.

Chemical adsorption amount (number of fullerene molecules/μm²)=Aa−Ap (3)

In the formula,

Aa: Total adsorption amount (number of fullerene molecules/μm²)

Ap: Physical adsorption amount (number of fullerene molecules/μm²)

### (Measurement of Friction Coefficient)

Using the structure as a sample, the average friction coefficient of the sliding surface of the structure was measured using a ball-on-disk friction test apparatus under the conditions of a ball (material: SUJ2, diameter: 6 mm), lubricating oil (Diana Fresia P-46, manufactured by Idemitsu Kosan Co., Ltd.), a load of 45 N, a circular orbit with a diameter of 8 mm, and a rotation speed of 30 rpm (linear velocity of 13 mm/sec), within the number of sliding movements ranging from 180 to 220 times (equivalent to a sliding distance of 4.5 m to 5.5 m).

### Example 1

0.500 g of iron (II) oxide powder (FeO, specific surface area 100 cm²/g, surface area 50 cm²) was used as iron oxide, to which 10 g of the immersion liquid was added, and immersion was performed while performing shaking for approximately 30 minutes. After that, the iron oxide powder was removed from the immersion liquid, washed with ethanol, air-dried, and dried on a hot plate at 50° C. to obtain a structure. The obtained structure was used as a sample to measure the total adsorption amount, the physical adsorption amount, and the chemical adsorption amount. The results are presented in Table 1.

### Example 2

The operations and measurements were performed in the same manner as in Example 1, except that 0.425 g of iron (III) oxide powder (Fe₂O₃, specific surface area 118 cm²/g, surface area 50 cm²) was used instead of the iron (II) oxide powder. The results are presented in Table 1.

### Comparative Example 1

The operations and measurements were performed in the same manner as in Example 1, except that 0.655 g of iron powder (Fe, specific surface area 76 cm²/g, surface area 50 cm²) was used instead of the iron (II) oxide powder. The results are presented in Table 1.

### Comparative Example 2

The operations and measurements were performed in the same manner as in Example 1, except that ethanol was used instead of the mixed solvent. The results are presented in Table 1.

### Comparative Example 3

The operations and measurements were performed in the same manner as in Example 1, except that the mixed solvent (that is, the fullerene concentration is 0) was used instead of the immersion liquid. The results are presented in Table 1.

TABLE 1

| | | | IRON | PHYSICAL | ADSORPTION |
|---|---|---|---|---|---|
| | COMPOSITION OF | | OXIDE | ADSORPTION | CHEMICAL |
| | SOLUTION USED FOR | | OR | AMOUNT | AMOUNT |
| | IMMERSION | | THE | (NUMBER/ | (NUMBER/ |
| | BENZOTRIAZOLE | FULLERENE | LIKE | μm²) | μm²) |
| EXAMPLE 1 | INCLUDED | INCLUDED | FeO | 1.0 × 10³ | 1.2 × 10⁵ |
| EXAMPLE 2 | INCLUDED | INCLUDED | Fe₂O₃ | 3.0 × 10³ | 9.2 × 10⁵ |
| COMPARATIVE | INCLUDED | INCLUDED | Fe | 2.2 × 10⁵ | 0 |
| EXAMPLE 1 | | | | | |
| COMPARATIVE | NOT | INCLUDED | FeO | 0 | 0 |
| EXAMPLE 2 | INCLUDED | | | | |
| COMPARATIVE | INCLUDED | NOT | FeO | 0 | 0 |
| EXAMPLE 3 | | INCLUDED | | | |

From the results of Examples 1 and 2 and Comparative Examples 1 to 3, it can be seen that when benzotriazole and fullerene are included in the components of the immersion liquid, fullerene is chemically adsorbed to the iron oxide. In Example 1, an increase in the total adsorption amount of fullerene was observed when the immersion time was 25 minutes and 30 minutes, but in Example 2, there was almost no difference between the immersion times of 25 minutes and 30 minutes. Therefore, it is considered that the adsorption amount almost reached the upper limit in Example 2.

### Example 3

A 5 mm thick test substrate made of steel (material: SUJ2) and having a 13 mm square mirror-finished surface on one side was immersed in 11 mass % sodium hydroxide aqueous solution at 80° C. for 3 minutes to form an iron oxide layer on the surface. Under these conditions, the iron oxide layer is considered to be a mixture of iron (II) and iron (III) oxides.

The test substrate on which the iron oxide layer was formed was washed with water and ethanol in this order, and then immersed in 10 ml of the immersion liquid for 35 minutes. During the immersion, the test substrate was ultrasonically stirred for the first 5 minutes, and then left to stand still.

After that, the substrate was taken out from the immersion liquid, and suspended and washed with ethanol. The ethanol on the surface of the substrate was removed by blowing nitrogen gas, and dried on a hot plate at 50° C. for 10 minutes to obtain a structure. The friction coefficient of the obtained structure was measured using the mirror-finished surface as a test surface. The results are presented in Table 2.

### Comparative Example 4

The operations and measurements were performed in the same manner as in Example 3, except that the mixed solvent (that is, the fullerene concentration is 0) was used instead of the immersion liquid. The results are presented in Table 2.

### Comparative Example 5

The operations and measurements were performed in the same manner as in Example 3, except that the sample was not immersed in the sodium hydroxide aqueous solution. The results are presented in Table 2.

TABLE 2

| | FULLERENE IN | | |
|---|---|---|---|
| | SOLUTION USED | OXIDE | FRICTION |
| | FOR IMMERSION | LAYER | COEFFICIENT |
| EXAMPLE 3 | INCLUDED | FORMED | 0.191 |
| COMPARATIVE | NOT INCLUDED | FORMED | 0.202 |
| EXAMPLE 4 | | | |
| COMPARATIVE | INCLUDED | NOT | 0.201 |
| EXAMPLE 5 | | FORMED | |

In Example 3, it is considered that fullerene was chemically adsorbed to the oxide layer because the oxide layer was treated in substantially the same manner as in Examples 1 and 2. From Table 2, the friction coefficient of Example 3 is approximately 5% smaller than that of Comparative Examples 4 and 5. It is considered that the friction reduction effect of fullerene was not exhibited because fullerene was not adsorbed in Comparative Example 4 and because no iron oxide layer was formed on the test surface of the substrate in Comparative Example 5.

The present application claims priority to Japanese Patent Application No. 2021-168395, filed Oct. 13, 2021 with the Japanese Patent Office, the contents of which are incorporated herein by reference in their entirety.

### INDUSTRIAL AVAILABILITY

The structure of the present invention can be usefully applied to a sliding material or the like.

1. A structure comprising:
an iron oxide; and
a fullerene,
wherein the fullerene is adsorbed on a surface of the iron oxide.

2. The structure according to claim 1, wherein the adsorption of the fullerene is a chemical adsorption.

3. The structure according to claim 1, wherein the iron oxide is magnetite.

4. The structure according to claim 1, wherein the fullerene covers an entirety of the surface of the iron oxide.

5. The structure according to claim 1, further comprising a metallic iron,
wherein the iron oxide is a film formed on a surface of the metallic iron.

6. A sliding material comprising:
the structure of claim 1,
wherein the structure is arranged such that the surface of the iron oxide having the fullerene serves as a sliding surface.

7. A manufacturing method of the structure of claim 1, the manufacturing method comprising:
a step of immersing an iron oxide in a benzotriazole solution containing a fullerene,
wherein the step of immersing is performed until a fullerene concentration in the benzotriazole solution decreases compared with that before the step of immersing, and
wherein the structure has the fullerene on the surface of the iron oxide.

8. The manufacturing method of the structure according to claim 7, wherein the benzotriazole solution further contains an alcohol.

9. The manufacturing method of the structure according to claim 7, wherein the step of immersing is performed until the fullerene concentration in the benzotriazole solution no longer changes after it has decreased compared with that before the step of immersing.

10. The manufacturing method of the structure according to claim 7, further comprising, after the step of immersing, a step of washing the structure with an alcohol and drying the structure.

11. A manufacturing method of a sliding material, wherein
a structure is obtained by the manufacturing method of claim 7, and
the surface of the iron oxide having the fullerene of the structure is arranged on a sliding surface.
